(19) United States
(12) Patent Application Publication
(10) Pub. No.: US 2011/0008195 A1
(43) Pub. Date: Jan. 13, 2011

(54) CENTRIFUGAL PUMP HAVING INCREASED OPERATIONAL SAFETY

(75) Inventor: Hubert Herrmann, Haimhausen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/743,219

(22) PCT Filed: Nov. 7, 2008
(86) PCT No.: PCT/DE08/01840

§ 371 Date: Aug. 20, 2010

(30) Foreign Application Priority Data
Nov. 17, 2007 (DE) 10 2007 054 947.6

(51) Int. Cl. F04B 17/00; H02H 7/08

(52) U.S. Cl. 417/423.7; 318/474

(57) ABSTRACT

An electric centrifugal pump for conveying a fluid, in particular for conveying fuel to an aircraft engine, is disclosed. The pump includes a housing in which a rotor shaft is rotationally mounted and an impeller for conveying the fuel which is arranged on the rotor shaft. A motor arrangement is provided for driving the rotor shaft in a rotary manner around a rotor axis. The impeller includes at least one rotor, and at least one stator is arranged in the housing in a plane-parallel manner adjacent to the rotor such that the rotor and the stator form the motor arrangement.

This application claims the priority of International Application No. PCT/DE2008/001840, filed Nov. 7, 2008, and German Patent Document No. 10 2007 054 947.6, filed Nov. 17, 2007, the disclosures of which are expressly incorporated by reference herein.

### BACKGROUND AND SUMMARY OF THE INVENTION

The present invention relates to an electrical centrifugal pump for conveying a fluid, in particular for conveying fuel to an aircraft engine, comprising a housing in which a rotor shaft is rotationally mounted and an impeller for conveying the fuel is arranged on the rotor shaft, wherein a motor arrangement is provided for driving the rotor shaft in a rotary manner around a rotor axis.

Centrifugal pumps feature a design, according to which the fluid to be conveyed is suctioned in axially from the direction of the rotor axis and flows off radially via the impeller. The housings of the electrical centrifugal pumps are adapted to the fluid flow path, and in most cases surround the impeller on the circumferential side. Pump arrangements are known from the prior art, which are connected to an electric motor via a drive shaft. Shaft sealing elements are required for this in order to seal the rotating shaft with respect to the housing. These types of shaft sealing elements have a high propensity to wear, wherein special risks can arise when conveying fuel if the fuel is able to exit from a damaged sealing element. In order to avoid the problem of the sealing elements, so-called wet motor pumps are known in which the motor arrangement is already arranged within the housing of the centrifugal pump. However, a drive shaft extends between the motor arrangement and the impeller such that the motor arrangement is arranged on the first end and the impeller on the opposing second end of the drive shaft. The result of this is a large structural shape of the centrifugal pump, wherein frequently the housing has a separating plane between the area of the motor arrangement and the area of the impeller.

In order to follow the general trend in the building of aircraft, realizing the increasing electrification of individual assemblies for operating an aircraft (MEE=more electric engine), fuel pumps which are operated exclusively by electric drives for conveying the fuel to the aircraft engine are required. The result is that, precisely with regard to the high level of required operational safety, a special safety requirement is accorded the electric centrifugal pump for conveying fuel to an aircraft engine.

More recent pump designs for fuel conveyance systems for aircraft engines provide for an electric drive that drives a pump module via a drive shaft. Both a failure of the motor arrangement as well as a failure of the sealing elements between the motor arrangement and the centrifugal pump can produce a failure of the fuel conveyance to the aircraft engine.

A fuel pump drive for an aircraft engine is known from German Patent Document No. DE 199 08 531 A1, which has a pump motor that drives a fuel pump via a pump shaft. Sealing the rotating pump shaft to the pump housing is accomplished by radial shaft sealing elements, which have a propensity to wear, that can lead to the failure of the fuel pump drive.

Another system for conveying fuel to an aircraft engine is disclosed in U.S. Pat. No. 6,675,570 B2, which also includes a motor that drives a pump arrangement via a rotating shaft. Frequently, several pumps are also arranged in series between a fuel tank and the aircraft engine, wherein a first pump conveys the fuel at a preliminary pressure and a second pump conveys the fuel with a further increased pressure into the combustion chamber of the aircraft engine. A combination of a mechanical drive via the engine in the form of a gear box and another electrical pump is also known. However, even in this case, the operational safety of the fuel conveyance device is restricted by the multitude of possible causes of failure such as a defective radial shaft seal or a failure of the electrical drive, for example from the winding body of the motor arrangement overheating.

As a result, the object of the present invention is to create a centrifugal pump which has a compact design with a high level of operational safety.

The invention includes the technical teaching that the impeller has at least one rotor, and at least one stator is arranged in the housing in a plane-parallel manner adjacent to the rotor, such that the rotor and the stator form the motor arrangement.

The inventive embodiment of an electrical centrifugal pump with an impeller that is simultaneously designed as a rotor or as a support for the rotor of a motor arrangement produces a very compact design of the pump. In particular, the advantage of this is that there is no drive shaft present between the motor arrangement and the impeller, which must be sealed vis-à-vis the housing by radial shaft sealing elements. Within the scope of the electrification of the individual technical components of an aircraft, the electrical centrifugal pump according to the invention is particularly suited for conveying fuel from a fuel tank to an aircraft engine. This pump design can be used both as a forepump in combination with a pump that is mechanically driven via the aircraft engine and as the only available pump between the fuel tank and the aircraft engine. According to the invention, the housing of the centrifugal pump surrounds both the impeller as well as the motor arrangement so that no dynamic seal is required, but only an inflow and outflow have to be sealed by means of a static sealing element.

According to an advantageous embodiment, a rotor and a stator are arranged on both sides of the impeller to form respective motor modules, which together form the motor arrangement. According to the invention, further motor modules can also be provided so that an electrically redundant motor design is made available, which has a lower probability of failure. The impeller is comprised of two plane-parallel disks, between which the blade elements for conveying the fuel are situated. The disks of the impeller can form the rotor of the motor arrangement either themselves or the rotor is arranged on each of the two disks of the impeller and has an annular structure.

The conveyed fluid advantageously circulates around the motor arrangement, so that the motor arrangement is designed like a type of a wet motor. The advantage of this is that no sealing elements are required even within the housing in order, for instance, to seal the motor arrangement vis-à-vis the impeller. A further advantage is the cooling effect, because the conveyed fluid, particularly the fuel conveyed to the aircraft engine, produces a cooling effect for the motor arrangement. The fuel circulates around both the rotor as well as the stator, on which at least one winding body is accommodated. The winding body may heat up during electrical operation of the motor arrangement, so that the quantity of heat generated is carried off by the fuel. The probability of a winding fire or a short circuit within the winding body is reduced because of the wet motor concept.

A further advantageous embodiment of the electrical centrifugal pump has a rotor shaft, which is designed as a hollow shaft, wherein the to-be-conveyed fluid enters the hollow shaft axially. In this case, it suffices for the hollow shaft to have an opening at least on one side in the direction of the rotor axis, into which the fuel, as the to-be-conveyed fluid, flows from the direction of the rotor axis in the hollow space of the hollow shaft. The hollow shaft can be designed as one piece with the impeller, wherein the hollow shaft is rotationally mounted within the housing by means of a roller bearing.

The impeller is advantageously fluidically connected to the hollow shaft, so that the fluid from the hollow shaft enters the impeller and for conveyance flows off radially via the impeller. The centrifugal pump is consequently designed as an axial radial pump, because the to-be-conveyed fluid flows into the pump axially and flows out of it radially. The embodiment, according to the invention of the rotor shaft as a hollow shaft with an impeller that is fluidically connected to the interior space of the hollow shaft and the arrangement of the rotor of the motor arrangement in or on the impeller, provides for a very compact design of the centrifugal pump in which the rotor of the motor arrangement as well as the impeller of the pump are designed in a component-integrated manner. The mounting of the rotor of the motor arrangement as well as the impeller of the pump is also accomplished by the double arrangement of a roller bearing on the front and rear ends of the rotor shaft, wherein the to-be-conveyed fluid also circulates around the bearing. The bearing can be designed as an enclosed bearing, wherein the bearing is advantageously also lubricated by the to-be-conveyed fluid. As a result, the mechanical failure of the roller bearing must be viewed as very remote, because at least overheating of the roller bearing can be ruled out.

According to an embodiment of the invention, the housing surrounds the rotor shaft radially and axially on one side. This means that the housing has an open end and a closed end, wherein the housing has a housing flange configured concentrically around the rotor axis for the axial inflow of the rotor shaft by the to-be-conveyed fluid, which flange is opposite from the closed side of the housing in the direction of the rotor axis, wherein the to-be-conveyed fluid enters the housing through the housing flange, wherein the housing can be flange-mounted and sealed on a receptacle via the housing flange. Consequently, the housing has only a fluid inlet and a fluid outlet, so that as a result only static seals are required.

The housing is preferably designed to be two-part, wherein the separating plane of the two housing halves lies in the extension plane of the impeller. This results in a simplified assembly of the centrifugal pump and of the integrated motor arrangement in particular, wherein the assembly can be carried from the direction of the motor axis. The two housing halves can be connected by screw elements, wherein furthermore a sealing element is provided for sealing the housing halves against each other.

The motor module features at least one winding body, which is connected to respectively assigned power electronics for supplying and triggering, wherein the power electronics make it possible in the event of a winding short-circuit to shut down the short-circuited winding body. A redundant structure of the motor arrangement is possible because of the separated connection of the individual motor modules. A motor module in this case includes at least one rotor and one stator with a winding body, which can drive the centrifugal pump when operated alone. In order to further increase the operational safety of the electrical centrifugal pump, separate power electronics are provided for each motor module and connected thereto. As a result, the electrical control of the centrifugal pump includes a number of power electronic units according to the number of motor modules. The power electronics are designed such that a winding body is shut down as soon as a winding short circuit occurs in the corresponding winding body. As a result, a winding fire can be avoided since the defective winding body is shut down directly and no further electric input of energy can take place. Moreover, the induction of a voltage can be avoided, which within a short-circuited winding body can also lead to an increase in temperature.

The rotors can be designed like a type of laminated, annular disk rotor, wherein they can have grooved squirrel cage windings on one side. An advantageous embodiment of the motor modules can be achieved by a design of an axial flow machine, which is designed as an asynchronous motor or as a reluctance motor with star-shaped, slotted rotors.

A further embodiment of the centrifugal pump features rotors, which are designed as magnetic rotors with inserted permanent magnets. However, the permanent magnets can also be inserted directly into the impeller, wherein the impeller is manufactured of a non-magnetic material. Using the permanent magnets in the impeller allows a further increase in the integration density, because no separate annular rotors that are arranged laterally on the impeller must be provided. The permanent magnets can be arranged on the circumference of the impeller in the lateral direction spaced apart at an equal distance from one other, wherein the arrangement is possible by screwing, adhesion or wedging in the impeller. The torque that is generated by such an arrangement of an axial flow machine is transmitted directly to the impeller, so that it is set into rotation together with the rotor shaft.

A further increase in the operational safety is achieved in that the individual motor modules made of a rotor and a stator have a rated power, which is respectively sufficient to drive the pump. In particular, subsequent damage can be avoided in this manner, because no fire or the like can occur in the event that a short-circuit motor winding is shut down. The power electronics assigned to the motor module can be designed in such a way that it permits a minimum or maximum power consumption of the motor winding within which the motor modules are operated. If the parameters for supplying the individual motor modules deviate from the specified minimum and maximum values, the motor module can be shut down automatically. The motor module which, as the remaining motor module, drives the pump can be actuated with a correspondingly higher power in order to equalize the failure of the defective motor module. As a result, despite a defect of a separate motor winding, there is no failure or interruption of the fuel supply of the aircraft engine, thereby enabling maximum operational safety.

Additional measures improving the invention are explained in greater detail in the following on the basis of the figures along with the description of a preferred exemplary embodiment of the invention.

### BRIEF DESCRIPTION OF THE DRAWINGS

FIG. 1 is a cross-sectional view of a centrifugal pump according to the invention with a motor module, which is comprised of at least one rotor and one stator with an associated winding body, arranged respectively on the left side as well as on the right side of the impeller; and

FIG. 2 is a motor arrangement with a total of four motor modules, each of which is comprised of a stator and a rotor.

### DETAILED DESCRIPTION OF THE DRAWINGS

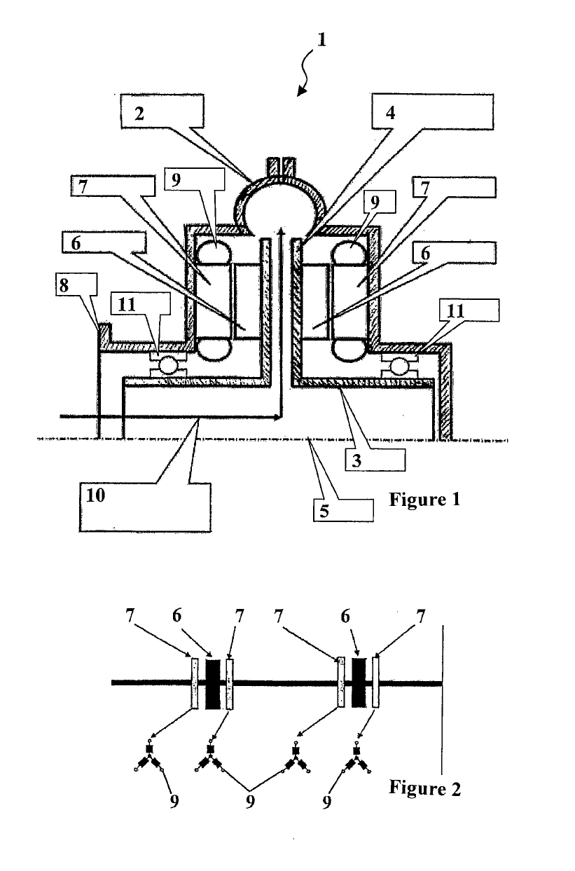

FIG. 1 depicts an electrical centrifugal pump according to the invention, which is identified by reference number 1. It is depicted in half section, wherein the rotor axis 5 forms the symmetry line and only the upper half section is shown. The housing 2 is designed to be two-part and has a closed rear portion and an open forward portion. The opening of the front part of the housing 2 is formed by the housing flange 8, through which the to-be-conveyed fluid can flow into the housing 2. The fluid flow path 10 is identified with an arrow, wherein after entering the housing 2, the fluid first enters a rotor shaft 3, which is designed as a hollow shaft. Arranged on the rotor shaft 3 is an impeller 4, which is fluidically connected to the interior area of the hollow shaft. As a result, the fluid flow path 10 first runs parallel to the rotor axis 5, so that the centrifugal pump receives inflow axially. After entering the hollow space of the rotor shaft 3, the fluid passes over to the impeller 4 and is accelerated radially outwardly. As a result, the fluid flows off from the pump radially. The impeller 4 has the structure of a surface plate, wherein, according to the inventive embodiment of the electrical centrifugal pump, a rotor 6 is arranged on the outer plane surface of the impeller 4 on both the left side as well as on the right side. Arranged inside the housing 2 plane-parallel to the left-side and right-side rotors 6 is a respective stator 7, on which a winding body 9 is attached. The arrangement of the rotor 6, the stator 7 and the winding body 9 together forms a separate motor module, so that, according to the present embodiment, two motor modules are integrated within the housing 2. Energizing the winding body 9 generates torque, which acts on the rotor 6. As a result, the impeller 4 is put into a rotational movement, so that the impeller is driven in rotating manner together with the rotor shaft 3.

The rotor shaft 3 is positioned in a roller bearing 11 within the housing 2, so that the centrifugal pump does not require dynamic seals. The rotating component is integrated exclusively within the housing 2, and no drive shaft exits from the housing in order to drive the impeller 4.

The electrical centrifugal pump 1 is designed as a wet motor, so that both the motor modules as well as the bearing 11 are subject to the to-be-conveyed fluid. The fluid circulates around both the bearing 11 as well as the rotors 6 and stators 7 and the winding body 9, and produces a cooling effect. Consequently, a failure of the centrifugal pump 1 because of a winding body 9 or a roller bearing 11 overheating is improbable, thereby further increasing the operational safety.

FIG. 2 depicts another exemplary embodiment of a possible motor arrangement, which is made of a total of four motor modules. Each motor module has a rotor 6 and a stator 7, on which a winding body 9 is respectively attached. The representation of the winding body 9 is depicted symbolically, wherein the winding body is a star circuit. The rotors 6 are designed as double acting rotors, so that the rotor forms a respective motor module with both the left-side as well as the right-side adjacent stator 7. The double arrangement of two stators 7 and one rotor 6 is provided on the rotor shaft twice so that in this case as well as the redundancy produces an increase in operational safety. The depicted rotors 6 can be respective impellers, so that the centrifugal pump 1 has a total of two impellers.

The invention is not restricted in terms of its design to the preferred exemplary embodiment indicated in the foregoing. In fact, a number of variations are conceivable that make use of the depicted attainment even with fundamentally different designs.

1-12. (canceled)

13. An electrical centrifugal pump for conveying a fluid, comprising:
a housing;
a rotor shaft rotationally mounted in the housing;
an impeller arranged on the rotor shaft;
a rotor arranged on an outer plane surface of the impeller;
a stator arranged in the housing in a plane-parallel manner adjacent to the rotor; and
a motor arrangement, wherein the rotor shaft is drivable by the motor arrangement in a rotary manner around a rotor axis and wherein the motor arrangement is formed by the rotor and the stator.

14. The electrical centrifugal pump according to claim 13, further comprising a second rotor and a second stator arranged on an opposing outer plane surface of the impeller, wherein the motor arrangement is additionally formed by the second rotor and the second stator, and wherein the rotor and the stator form a first motor module and the second rotor and the second stator form a second motor module.

15. The electrical centrifugal pump according to claim 13, wherein the fluid is circulatable around the motor arrangement.

16. The electrical centrifugal pump according to claim 13, wherein the rotor shaft is a hollow shaft and wherein the fluid is axially receivable in the hollow shaft.

17. The electrical centrifugal pump according to claim 16, wherein the impeller is fluidically connected to the hollow shaft and wherein fluid from the hollow shaft is receivable in the impeller and is radially conveyable via the impeller.

18. The electrical centrifugal pump according to claim 13, wherein the housing surrounds the rotor shaft radially and axially on a side, wherein the housing has a housing flange configured concentrically around the rotor axis for an axial inflow of the fluid in the rotor shaft and for entry of the fluid in the housing, and wherein the housing flange flange-mounts and seals the housing on a receptacle.

19. The electrical centrifugal pump according to claim 13, wherein the housing comprises two-parts and wherein a separating plane lies in an extension plane of the impeller.

20. The electrical centrifugal pump according to claim 13, wherein the motor arrangement has a winding body which is connected to a power electronics and wherein the power electronics shuts down the winding body in an event of a short-circuit of the winding body.

21. The electrical centrifugal pump according to claim 13, wherein the rotor is a laminated, annular disk rotor and has a grooved squirrel cage winding on a side.

22. The electrical centrifugal pump according to claim 13, wherein the motor arrangement is an asynchronous motor that acts like a type of axial flow machine or as a reluctance motor with a star-shaped, slotted rotor on a side.

23. The electrical centrifugal pump according to claim 13, wherein the rotor is a magnetic rotor with inserted permanent magnets or wherein the permanent magnets are inserted directly into the impeller to form the rotor, and wherein the impeller is a non-magnetic material.

24. The electrical centrifugal pump according to claim 14, wherein the first and second motor modules have a rated power which is respectively sufficient to drive the centrifugal pump.
